(19) United States
(12) Patent Application Publication
(10) Pub. No.: US 2016/0083605 A1
(43) Pub. Date: Mar. 24, 2016

(54) WATER AND OIL-REPELLENT FLUOROPOLYMER HAVING A SHORT PERFLUORINATED CHAIN

(71) Applicants: Shijun FENG, (US); Yun LIN, Shanghai (CN)

(72) Inventors: Shijun FENG, Shanghai (CN); Yun LIN, Shanghai (CN)

(21) Appl. No.: 14/889,047

(22) PCT Filed: May 8, 2013
(86) PCT No.: PCT/CN2013/075321

§ 371 Date: Nov. 4, 2015

(51) Int. Cl. C09D 127/12; D06M 11/79; D06M 15/256

(52) U.S. Cl. CPC C09D 127/12; D06M 15/256; D06M 11/79; C08K 3/36

(57) ABSTRACT

Disclosed water and oil repellent coatings for textile fabrics having a low surface energy portion having a polyolefin having a R^{f} of 4 or less, and a nanometer portion which has nanoparticles. Also disclosed coated fabrics, as well as methods for making the coated fabrics.

### FIELD OF THE INVENTION

The present invention relates to fluorinated polymers having water and oil-repellent properties. More specifically, the present invention relates to the coating of textile fabrics with such fluorinated polymers.

### BACKGROUND OF THE INVENTION

For many years, a popular and typical method for imparting water/oil repellency to a surface of an article (e.g., fiber products, PET synthesized fibers) was to immerse substrates into a coplymer emulsion having structural units based on a monomer having a polyfluoroalkyl group having at least 8 carbon atoms. See, for example, U.S. Pat. No. 5,334,903 (Raiford et al), U.S. Pat. No. 4,321,404 (Williams et al.), U.S. Pat. No. 5,144,056 (Anton et al.) and U.S. Pat. No. 5,446,118 (Shen et al.).

However, as discussed in, inter alia, U.S. Pat. No. 5,688,884 (Baker et al.), the United States Environmental Protection Agency (EPA) has made findings that a compound having a perfluoroalkyl group (R^{f} group) with at least 8 carbon atoms is slow to decompose, is likely to be bio-accumulated in living organisms, and potentially presents a high impact on the environment. Accordingly, studies have been made to determine whether a polymer or copolymer which has structural units based on a monomer having a R^{f} group having less than 8 carbon atoms would be effective as a water/oil repellent composition.

For example, Takao et al. (U.S. Patent Application Publication No. 2012/0259045) discloses the use of perfluoroalkyethyl acrylate/vinylidene chloride/alkyl(meth)acrylate copolymer emulsions, which, after application to nylon and polyester cloths from an emulsion formulation, imparted oil and water repellency to the substrates. The chemical formula for a perfluoroalkyl ethyl acrylate monomer is used by Takao et al. is as follows:

CF₃(CF₂)₅—C₂H₄—OC(O)CH═CH₂

Gregg et al. (U.S. Patent Application Publication No. 2007/0173149) disclose another kind of fluoroacrylate having an R^{f} group having less than 6 carbon atoms, which is even shorter than the monomer used by Takeo et al. For example, the chemical structure of one monomer used by Gregg et al. is as follows:

CF₃(CF₂)₃SO₂N(CH₃)(CH₂)ₘ—OC(O)NH—(C₆H₄—CH₂—C₆H₄)—HNC(O)O—(CH₂)ₙ(O)COC═CH₂

(m=2 to 8, n=2 to 30)

As likewise indicated in Gregg et al., it was expected that having fewer R^{f} groups made the compounds less toxic and less bioaccumulative than 6 carbon or 8 carbon perfluorinated groups, while maintaining good water/oil repellency ability.

Accordingly, there is a need to develop fluoropolymer which is even more environmentally conscious, e.g., having fewer than R^{f} groups and having relatively good hydrophobic and oleophobic properties.

### SUMMARY OF THE INVENTION

The present invention addresses this need by providing fluoropolymers having fewer than 4 R^{f} groups which can be used for water and oil repellency coatings, and can serve in coating solutions on articles such as woven and nonwoven textile fabrics made from natural and/or synthetic fibers, including, but not limited to, cotton, cellulose, wool, silk, polyamide, polyester, polyolefin, polyacrylonitrile, paper, and leather.

In accordance with a first aspect of the present invention, a water and oil repellent coating for textile fabrics is provided, the coating having a low energy portion containing the polyolefin, and a nanometer portion containing nanoparticles which change the morphology of the textile fabric. Preferably, the polyolefin comprises at least one fluoropolymer represented by the following formula:

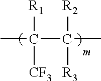

wherein R₁, R₂, R₃ are each selected from H, Cl and F, m is an integer, and the polymer has a molecular weight between 1000 and 100,000. Preferably, this polymer can be synthesized in presence of initiator in a reaction solution.

In accordance with a second aspect of the present invention, a textile fabric having the coating in accordance with the first aspect is provided.

In accordance with a third aspect of the present invention, a method of a coating the textile fabric with the coating of the first aspect is provided.

### BRIEF DESCRIPTION OF THE DRAWINGS

A specific example has been chosen for purposes of illustration and description, and is shown in the accompanying drawing, forming a part of the specification.

FIG. 1 is a flow chart of a method of producing an water and oil repellent coating on fabrics.

### DETAILED DESCRIPTION

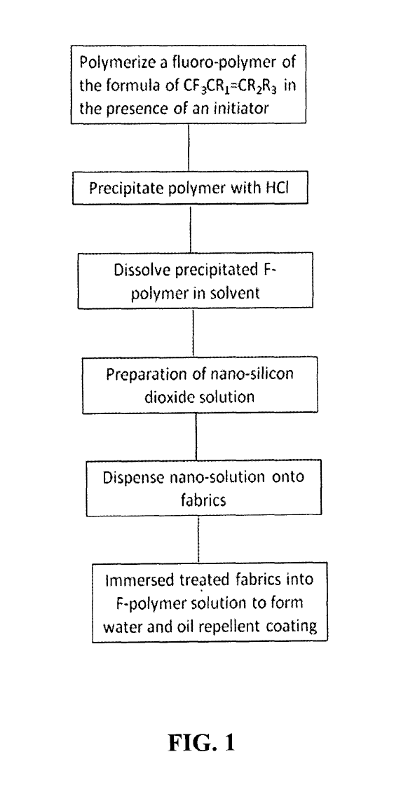

FIG. 1 is a flow chart illustrating a method of forming an hydrophobic and olephobic coating on fabrics. According to the method, water/oil repellent coating is formed by polymerizing a fluorocarbon compound of the general formula CF₃CR₁═CR₂R₃ in the presence of an initiator and under suitable reaction conditions. The resulting polymer is represented by the following formula:

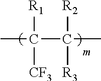

wherein R₁, R₂, R₃ are each selected from H, Cl and F, and the polymer has a molecular weight between 1000 and 100,000.

After forming the polymer, acid may be added to precipitate the polymer. The precipitated polymer may then be filtered, dried and combined with common organic solvent to form a key component (i.e., component A). A variety of commercially available hydrofluoroolefins or (HFOs) may be used to prepare the fluoropolymer. Suitable HFOs may have the general formula CF₃CR₁═CR₂R₃, wherein R₁, R₂, R₃ are each selected from H, Cl and F. Suitable HFOs include tetrafluoropropene compounds and pentafluoropropene compounds. A preferred tetrafluoropropene compound is 2,3,3,3-tetrafluoro-1-propene (HFO-1234yf), which forms a polymer having the following formula:

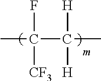

Other suitable tetrafluoropropene compounds include HFO-1234ze, HFO-1233zd, and HFO-1234zf. Suitable pentafluoropropene compounds include HFO-1225. Stereoisomers of any the foregoing compounds may also be suitable.

Polymerization is preferably carried out in the presence of one or more free-radical initiators. Suitable initiators include azodiisobutyronitrile, 2,2′-azobis(2-methylpropionamide)dihydrochloride, aliphatic perester such as tertbutylhydroperoxide, persulfates such as sodium persulfate, potassium persulfate, ammonium persulfate, and iron persulfate, and combinations of the foregoing. A persulfate initiator may be particularly suitable for the present invention. The initiator may be less than 10 wt %, more particularly less than 5 wt % and even more particularly less than 1.0 wt % based on the total weight of monomer.

A preferred method for synthesizing a 1234yf homo-polymer in accordance with the present invention is emulsion polymerization. One benefit of this method is that no chlorofluorocarbon or common solvents are used. The process is environmentally benign. Other common alternative methods, such as solution polymerization and bulk polymerization may also be used.

Surfactants which may used during the preparation of 1234yf homo-polymer include, but are not limited to, fluorosurfactants and hydrocarbon surfactants (such as sodium octyl sulfonate, sodium dodecylsulfonates, sodium decyl sulfate, sodium caprylate, sodium stearate, and nonylphenolpoly(ethylene oxide)). Preferably, fluorosurfactant or perfluorinated carboxylic acid is employed, such as the ammonium perfluorooctonoate in the specific examples.

The 1234yf homopolymer produced in accordance with the present invention was identified by NMR method and elemental analysis. As shown in Table 1 below, the 1234yf homopolymer has good solubility in some common organic solvents, such as ethyl acetate and methyl ethyl ketone. Accordingly, fluoropolymers can be used to coat fabrics in solution form. Preferably the coating solutions are between 0.5 and 95 wt % fluoropolymer, and even more preferably, between 0.5 and 5.0 wt % fluoropolymer.

TABLE 1
Homo-1234yf solubility test results

| Solvent | Solubility |
|---|---|
| Chloroform | Insoluble |
| Ethylene glycol | Insoluble |
| Propylene glycol | Insoluble |
| Petroleum ether | Insoluble |
| Ethanol | Insoluble |
| Methanol | Insoluble |
| Isopropanol | Insoluble |
| Isobutanol | Insoluble |
| Ethyl acetate | Soluble |
| Acetone | Soluble |
| Methyl ethyl ketone | Soluble |
| Tetrahydrofuran | Soluble |

Preferred nanoparticles for the present invention include silicon dioxide, zinc oxide, titanium dioxide, aluminum oxide and combinations of the foregoing. Example 2 below provides a typical procedure for producing nanoparticles. This nanoparticle dispensed solution (i.e., component B) is preferably used to form the bottom layer on the textile fabrics before making an upper, low-surface energy fluoropolymer layer coating.

Preferred textile fabrics include, but are not limited to, a variety of woven and nonwoven textile fabrics made from natural or synthetic fibers including cotton, cellulose, wool, silk, polyamide, polyester, polyolefin, polyacrylonitrile, and rayon.

### EXAMPLES

### Example 1

### Polymerization of 2,3,3,3-tetrafluoro-1-propene polymer (Homo-1234yf)

To a 1000 mL autoclave was added 450 mL deionized water, 6 g ammonium perfluorooctonoate, 1.2 g ammonium persulfate, 3.36 g Na₂HPO₄ and 2.22 g NaH₂PO₄.2H₂O. After 3 cycles of deoxygenation with nitrogen, the mixture solution was cooled to 0° C., 360 g 2,3,3,3-tetrafluoropropene monomer was charged into the high pressure reactor via a pump over a period of 5 minutes, during which the reactor contents were stirred at 200 rpm. After the monomer feeding step, the reactor was held at 400 rpm and 70° C. After 48 hours, the polymerization was stopped and excessive gas was released from the autoclave. The polymerization latex was coagulated in 25% HCl and the polymerization product was washed with distilled water and dried 50° C. overnight. Finally, 237.15 g white polymer was obtained with a yield of 66%. The product was an amorphous fluoroelastomer having a glass transition temperature of 54° C. as determined by differential scanning calorimetry (DSC). Fluorine content was found to be 66.5%.

### Example 2

### Preparation of Silicon Dioxide Nanoparticle Solution

To a 250 mL round bottom flask with a magnetic stirrer was added 10 mL deionized water, 25 mL ethanol and 35 mL tetraethyl orthosilicate. After 10 minutes reaction at room temperature at a stirring speed of 400 rpm, a few drops of base and/or acid was added to the reaction solution slowly. After 2 hours, the silicon dioxide nanoparticle solution is formed and can be used directly.

### Example 3

### Preparation of Water and Oil Repellent Coating on Fabric

An amount of the Homo-1234yf solid was diluted with butanone to a polymer content of 0.5-5% as component A, silicon dioxide nanoparticle solution prepared above is used as component B. The fabrics selected for testing included a blue nylon, PET, a polyolefin nonwoven, and undyed cotton fabrics. Prior to testing, the polyolefin fabric was dried at room temperature for 24 hours and then heat-treated at 38° C. for 10 seconds. The nylon fabric was air dried for 24 hours before use. The fabrics were immersed into component B system first for 3 minutes, followed by curing at 80° C. for 3 minutes, and 150° C. for 3 minutes respectively. After forming a first nanolayer, fabrics were then immersed into component A, and dried at 150° C. for 3 minutes to make a layer of hydrophobic and olephobic coating. The two layer coating imparted the fabrics with good water and oil repellency.

### Example 4

### Average Particle Size

The silicon dioxide nanoparticle solution was diluted to 0.05 mass % with distilled water which had been passed through a 50 μm filter to obtain a sample. The average particle size of the sample was measured by dynamic light scattering method via a particle size measurement. system. The average particle size was found to be 180 nm.

### Example 5

### Water Repellency Spray Test

With respect to a test cloth, the water repellency was evaluated in accordance with the spray test method (AATCC standard test method No. 22). During the test, 250 ml of water was poured in a narrow stream at a 27 degree angle onto a fabric sample stretched on a 6-inch (15.2 cm) diameter plastic hoop, discharged from a funnel suspended 6 inches above the fabric sample. After removal of excess water, the fabric was visually scored by reference to published standards. A rating of 100 denotes no water penetration or surface adhesion; a rating of 90 denotes slight random sticking or wetting, and lower values indicate greater wetting. A rating of 0 indicates complete wetting. Testing results for water repellency rating were 95 for PET, 95 for nylon and 90 for cotton fabric respectively, indicating very good water repellency which results in the beading of water on the fabrics.

### Example 6

### Oil Repellency Test

The treated fabric samples were tested for oil repellency by a modification of AATCC standard test method No. 118. A series of organic liquids, identified below in Table 2 were introduced dropwise to the fabric samples. Beginning with the lowest numbered test liquid (Repellency rating No. 1), one drop (0.05 mL volume) was placed on each of three locations at least 5 mm apart. The drops were observed for 30 seconds. If, at the end of this period, two of the three drops were still spherical to hemispherical in shape with no wicking around the drops, three drops of the next highest numbered liquid were placed on adjacent sites and similarly observed for 30 seconds. The procedure was continued until one of the test liquids results in two of the three drops failing to remain spherical to hemispherical, or wetting or wicking occurs. The oil-repellency rating of the fabric is the highest numbered test liquid for which two of the three drops remain spherical to hemispherical, with no wicking for 30 seconds.

TABLE 2

| Rating | Oil repellency test liquid | γ_{L}, mN/m |
|---|---|---|
| 1 | Nujol | ≧ |
| 2 | 65% Nujol^{a} | 28 |
| 3 | n-hexadecane | 27.6 |
| 4 | n-tetradecane | 26.7 |
| 5 | n-dodecane | 25.4 |
| 6 | n-decane | 23.9 |
| 7 | n-octane | 21.8 |
| 8 | n-heptane | 20.0 |

^{a}Vol % In n-hexadecane

Via the testing, oil repellency rating was found to be 4 for PET, 4 for Nylon and 3 for cotton fabrics, indicating that the fabrics have good oil repellency rating.

What is claimed is:

1. A water and oil repellent coating for textile fabrics comprising:
a low surface energy portion comprising polyolefin having an R^{f} of 4 or less; and
a nanometer portion comprising nanoparticles.

2. The water and oil repellent coating of claim 1, wherein the polyolefin comprises polymer of a formula 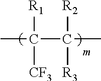
wherein R₁, R₂, R₃ are each selected from H, Cl and F, and the polymer has a molecular weight between 1000 and 100,000.

3. The water and oil repellent coating of claim 2, wherein the polyolefin is selected from the group consisting of tetrafluoropropene and pentafluoropropene compounds.

4. The water and oil repellent coating of claim 3, wherein said tetrafluoropropene and pentafluoropropene compounds are selected from the group consisting of: HFO-1234yf, HFO-1234ze, HFO-1233zd, HFO-1234zf, HFO-1225, stereoisomers thereof, and combinations thereof.

5. The water and oil repellent coating of claim 1, wherein the nanoparticles comprise a nanoparticle selected from the group consisting of: silicon dioxide, zinc oxide, titanium dioxide, aluminum oxide, and combinations thereof.

6. The water and oil repellent coating of claim 5, wherein the nanoparticles consist essentially of nanoparticles selected from the group consisting of: silicon dioxide, zinc oxide, titanium dioxide, aluminum oxide, and combinations thereof.

7. A textile fabric coated with the water and oil repellent coating of claim 1, wherein the water and oil repellent coating comprises at least:
a first layer and a second layer, the first layer being adjacent to said textile fabric and comprising said nanometer portion,
a second layer comprising said low surface energy portion,
wherein said first layer is located between said textile fabric and said second layer.

8. The textile fabric according to claim 1, wherein the textile fabric is selected from the group consisting of cotton, cellulose, wool, silk, polyamide, polyester, polyolefin, polyacrylonitrile, and rayon.

9. A method of coating a textile fabric with the water and oil repellent coating according to claim 1, comprising the steps of:
coating at least a portion of the textile fabric with a solution comprising said nanoparticles; and
coating said portion with a solution comprising the polyolefin having an R^{f} of 4 or less.

10. The method according to claim 9, further comprising the step of preparing the solution comprising the polyolefin.

11. The method according to claim 10, wherein preparing the solution comprises the steps of:
polymerizing a fluoropolymer having a formula of 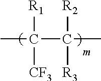
wherein R₁, R₂, R₃ are each selected from H, Cl and F, the fluoropolymer having a molecular weight between 1000 and 100,000;
precipitating the fluoropolymer; and
dissolving the precipitated fluoropolymer in at least one solvent.

12. The method according to claim 11, wherein the fluoropolymer is selected from the group consisting of tetrafluoropropene and pentafluoropropene compounds.

13. The method according to claim 12, wherein said tetrafluoropropene and pentafluoropropene compounds are selected from the group consisting of: HFO-1234yf, HFO-1234ze, HFO-1233zd, HFO-1234zf, HFO-1225, stereoisomers thereof, and combinations thereof.

14. The method according to claim 13, wherein the nanoparticles comprise a nanoparticle selected from the group consisting of: silicon dioxide, zinc oxide, titanium dioxide, aluminum oxide, and combinations thereof.

15. The method according to claim 14, wherein the nanoparticles consist essentially of nanoparticles selected from the group consisting of: silicon dioxide, zinc oxide, titanium dioxide, aluminum oxide, and combinations thereof.
